(19) United States
(12) Patent Application Publication
(10) Pub. No.: US 2013/0246290 A1
(43) Pub. Date: Sep. 19, 2013

(54) Machine-Assisted Legal Assessments

(71) Applicant: PRECISION LITIGATION, LLC, Atlanta, GA (US)

(72) Inventors: Gardner G. Courson, Atlanta, GA (US); David Pensak, Wilmington, DE (US)

(73) Assignee: Precision Litigation, LLC, Atlanta, GA (US)

(21) Appl. No.: 13/829,207

(22) Filed: Mar. 14, 2013

Related U.S. Application Data
(60) Provisional application No. 61/612,048, filed on Mar. 16, 2012.

(51) Int. Cl. G06Q 50/18; G06Q 10/10

(52) U.S. Cl. CPC G06Q 50/18; G06Q 10/10
USPC 705/311

(57) ABSTRACT

Disclosed are various embodiments for determining and/or providing machine-assisted legal assessments. User input may be provided by a user to an input mechanism through an ingestion process. An assessment engine may compare user input provided at a state of the ingestion process to one or more decision frameworks in order to determine probabilities, estimated expenditures, recommendations, and/or suggestions. An output control may export the decision frameworks and/or any stored or generated data according to predefined agreement constraints.

This application claims the benefit of and priority to U.S. Provisional Application Ser. No. 61/612,048 entitled “Method of Optimizing Case Assessment and Damage Estimates in Complex Civil Litigation,” filed Apr. 16, 2012, the entire contents of which is hereby incorporated herein by reference.

### BACKGROUND

The know-how of attorneys is primarily relied upon in making determinations at countless stages of a legal cause of action. Typically, attorneys rely on their personal experiences in determining whether to pursue various courses of actions. These personal experiences may exhibit unknown biases which may not accurately reflect chances of success and/or estimations of expenditures. Moreover, attorneys may not know and/or understand all case law relevant to a particular case. Accordingly, the reliance on attorneys in various stages of the legal process remains problematic.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example flow chart displaying options that may pursued during the legal process.

FIG. 2 is a drawing of a networked environment according to various embodiments of the present disclosure.

FIGS. 3A-D are drawings of additional data that may reside in a data store in the networked environment according to various embodiments of the present disclosure.

FIG. 4 is a drawing of an example flow chart further comprising probabilities and/or estimated expenditures for various options that may pursued during the legal process.

FIG. 5 is a drawing of an example of a user interface rendered by a client in the networked environment of FIG. 2 according to various embodiments of the present disclosure.

FIG. 6 is a drawing of an example of a user interface rendered by a client in the networked environment of FIG. 2 according to various embodiments of the present disclosure.

FIG. 7 is a drawing of an example of a user interface rendered by a client in the networked environment of FIG. 2 according to various embodiments of the present disclosure.

FIG. 8A is a flowchart illustrating one example of functionality implemented as portions of a teaching mechanism executed in a computing environment in the networked environment of FIG. 2 according to various embodiments of the present disclosure.

FIG. 8B is a flowchart illustrating one example of functionality implemented as portions of a teaching mechanism executed in a computing environment in the networked environment of FIG. 2 according to various embodiments of the present disclosure.

FIG. 9 is a flowchart illustrating one example of functionality implemented as portions of an assessment engine executed in a computing environment in the networked environment of FIG. 2 according to various embodiments of the present disclosure.

FIG. 10 is a schematic block diagram that provides one example illustration of a computing environment employed in the networked environment of FIG. 2 according to various embodiments of the present disclosure.

### DETAILED DESCRIPTION

The know-how of attorneys is primarily relied upon in making determinations whether to settle or litigate a legal cause of action. Typically, attorneys rely on personal experiences in determining whether to pursue various courses of actions. For example, an attorney may render a legal opinion based on a personal experience the attorney had with a similar type of legal case. The personal experiences may exhibit unknown biases which may not accurately reflect chances of success and/or estimations of expenditures. For example, an attorney may recommend litigating a case, when in reality there is little or no chance of success.

Moreover, attorneys may not know and/or understand all case law relevant to a particular case. As may be appreciated, case law is constantly expanding and/or changing as are the judges who are administering the law. It remains difficult, if not impossible, for attorneys to maintain a mental database full of relevant information for a variety of legal cases. Thus, the reliance on attorneys in various stages of the legal process remains problematic.

A system may be implemented that may maintain and utilize vast libraries of probabilities, legal opinions, settlement histories, judgment histories, and/or any other relevant information to precisely determine probabilities of success for a unique legal case. Moreover, the system may determine all possible courses of action that may be taken, the probabilities of success for each course of action, and/or an estimated expenditure required to complete a course of action. The system may utilize one or more decision frameworks to analyze a case provided via user input. In the following discussion, a general description of the system and its components is provided, followed by a discussion of the operation of the same.

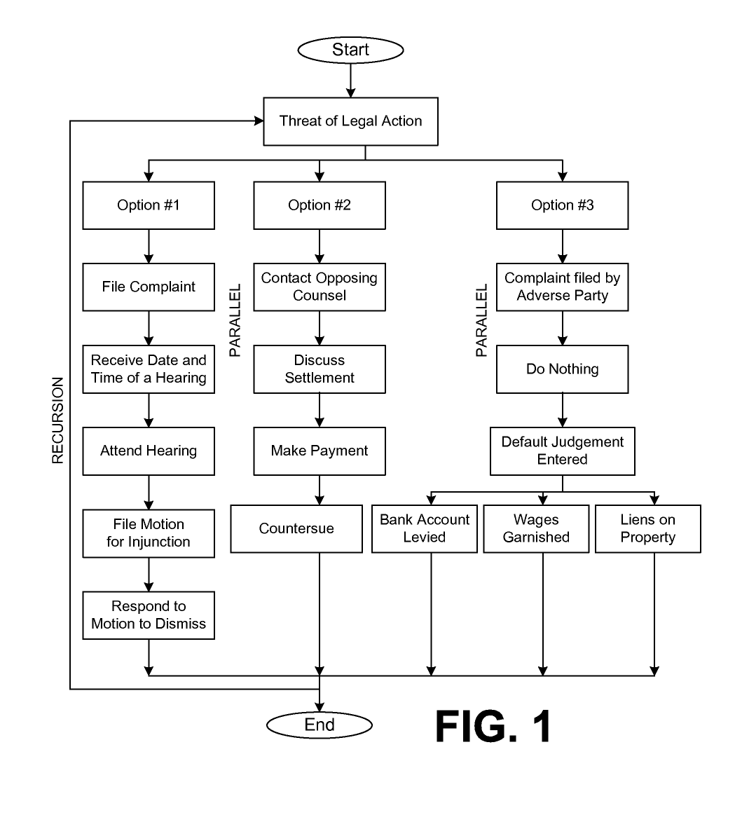

With reference to FIG. 1, shown is a non-limiting example of a flowchart displaying which courses of actions may be pursued in anticipation of litigation and/or after a legal complaint is filed. As may be appreciated, the potential courses of action that may be taken in a legal case are vast and complex. Accordingly, a system may be employed to facilitate analysis of a legal case while providing probabilities and estimated expenditures of each potential course of action. Moreover, the analysis may be used prior to existent of a legal complaint and may go beyond settlement and/or a verdict. For example, analysis may continue on potential post-settlement and/or post-verdict expenses.

Next, a discussion of the computing environment is provided in which automated legal assessments are determined followed by a discussion of the operation of the same.

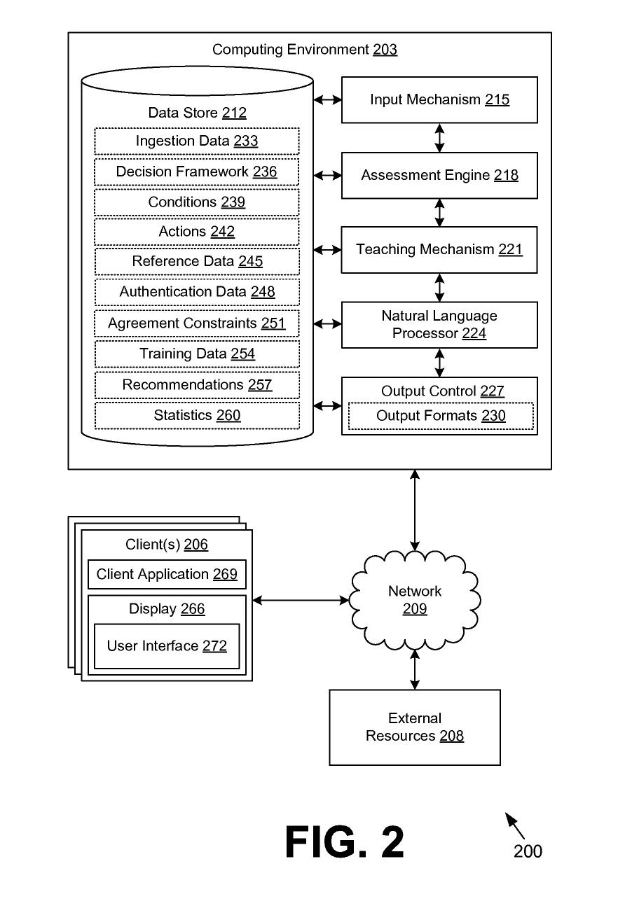

With reference to FIG. 2, shown is a networked environment 200 according to various embodiments. The networked environment 200 includes a computing environment 203, a client device 206, and external resources 208, which are in data communication with each other via a network 209. The network 209 includes, for example, the Internet, intranets, extranets, wide area networks (WANs), local area networks (LANs), wired networks, wireless networks, or other suitable networks, etc., or any combination of two or more such networks.

The computing environment 203 may comprise, for example, a server computer or any other system providing computing capability. Alternatively, the computing environment 203 may employ a plurality of computing devices that may be employed that are arranged, for example, in one or more server banks or computer banks or other arrangements. Such computing devices may be located in a single installation or may be distributed among many different geographical locations. For example, the computing environment 203 may include a plurality of computing devices that together may comprise a cloud computing resource, a grid computing resource, an artificial neural network (ANN), and/or any other distributed computing arrangement. In some cases, the computing environment 203 may correspond to an elastic computing resource where the allotted capacity of processing, network, storage, or other computing-related resources may vary over time.

Various applications and/or other functionality may be executed in the computing environment 203 according to various embodiments. Also, various data is stored in a data store 212 that is accessible to the computing environment 203. The data store 212 may be representative of a plurality of data stores 212 as can be appreciated. The data stored in the data store 212, for example, is associated with the operation of the various applications and/or functional entities described below.

The components executed on the computing environment 203, for example, include an input mechanism 215, an assessment engine 218, a teaching mechanism 221, a natural language processor 224, an output control 227, and potentially other applications, services, processes, systems, engines, or functionality not discussed in detail herein. The input mechanism 215 is executed to obtain input from a user. For example, the input mechanism 215 may prompt users with one or more requests for user input. Additionally, the input mechanism 215 may receive the user input, provided by the user, and store the user input in data store 212. As a non-limiting example, the input mechanism 215 may pose a user with one or more questions during an ingestion process by rendering a series of user interfaces comprising one or more questions, whereby the input mechanism 215 obtains data from the user in response to the user answering the one or more questions posed. Similarly, the input mechanism 215 may prompt the user to provide user input via by requesting the user to provide one or more documents (e.g., discovery files, legal opinions, etc., that may be uploaded or otherwise obtained).

The input mechanism 215 may further be executed to store, modify, and/or resume the state of the ingestion process regardless of a time elapsed during various stages of the ingestion process. Thus, the ingestion process may be shutdown at various stages while permitting a user to resume the ingestion process at a saved state. Alternatively, the ingestion process may be restarted by the input mechanism 215, if necessary or warranted.

In determining which questions to pose to a user, the input mechanism 215 may employ one or more decision frameworks. Decision frameworks may comprise, for example, various decision algorithms and/or learning mechanisms, as will be discussed in greater detail below. As a non-limiting example, a question may be posed to a user based at least in part on a response previously provided by the user. Accordingly, the subsequent questions posed to the user may vary depending on the previously provided user input. Questions may be posed in sequence, in parallel, iteratively, and/or randomly depending on user input provided by a user in one or more previously presented questions.

The assessment engine 218 is executed to analyze user input in order to determine probabilities, estimated expenditures, statistics, models, flowcharts, applicable scenarios in decision frameworks, subsequent applicable scenarios in decision frameworks, etc., based at least in part on the user input and/or reference data. In one embodiment, the assessment engine 218 may analyze the user input to determine the probabilities of obtaining a successful outcome of a legal case presented. User input obtained during an ingestion process by the input mechanism 215 may comprise, for example, a venue, a jurisdiction, the laws in a particular jurisdiction, a judge presiding in a case, legal opinions in the jurisdiction, settlement history, verdict history, discovery documents, and/or other information. Moreover, estimated expenditures may be calculated for each step in the litigation process. The assessment engine 218 may identify applicable scenarios in one or more decision frameworks 236 by comparing a state of the ingestion process to one or more nodes in the decision frameworks 236. Moreover, weights defined by a user of the system may be used in determining subsequent applicable scenarios in the one or more decision frameworks 236.

The assessment engine 218 may further determine a bias and/or truthfulness of user input measured as a confidence score using known techniques. The confidence score may be stored in data store 212 and may be associated with the user input provided by during the ingestion process. Moreover, the confidence score may be used in determining a credibility score corresponding to the user. Accordingly, user input with a confidence score meeting and/or exceeding a predefined threshold may be used in the determination of probabilities, suggestions, recommendations, etc. Similarly, user input provided by a user with a credibility score meeting and/or exceeding a predefined threshold may be used.

The assessment engine 218 may be further configured to determine whether user input provided by one or more users comply with discovery for a particular jurisdiction. For example, a user may provide user input corresponding to a jurisdiction associated with a particular legal case. The assessment engine 218 may access reference data 245 to determine applicable discovery laws in the particular jurisdiction and/or court. The assessment engine 218 may determine whether user input complies with the applicable discovery laws and may implement an intervention in the ingestion process (e.g., by providing the user with a series of user interfaces comprising notifications that state that discovery laws are in and/or out of compliance), if warranted. Similarly, the assessment engine 218 may determine whether the data relied upon in making an assessment and/or suggestion meets a standard for a particular court and/or jurisdiction.

The teaching mechanism 221 is executed to employ machine learning to improve the derivation of meaning from documents and/or user input. As may be appreciated, human language is constantly changing and evolving. Accordingly, the teaching mechanism 221 may identify new terms (e.g., new laws, slang terms, legal terms, etc.) using known machine learning strategies. The teaching mechanism 221 may communicate with external services 208 to define identified new terms to be employed in future derivations. In addition to new words or phrases, the teaching mechanism 221 may employ known machine learning techniques to identify relevancy of documents, portions of documents, and/or portions of user input. By employing machine learning, future identification and/or meaning derivation may have a higher degree of accuracy in being classified as relevant or irrelevant.

The teaching mechanism 221 has the ability to “learn” based on input provided from users, administrators, attorneys, analysts, etc., during an ingestion process or by modifying (automatically and/or manually) data residing in data store 212. The teaching mechanism 221 may flag non-unanimity of opinion provided and may present, for example, a source of the input and the non-unanimous opinions to the user. Similarly, the teaching mechanism 221 may identify conflict detection based on user input provided from a plurality of authorized users. For example, a legal case may be associated with both in-house counsel (e.g., attorneys working for a company) and outside counsel (e.g., attorneys in a law firm hired by the company), both authorized to access information associated with the same legal case. Accordingly, if an in-house attorney provides user input conflicting with an outside attorney, the conflict may be identified and/or presented to the users of the system. Moreover, different weights may be provided to the decisions of particular attorneys, if so requested by the user input. For example, more weight may be afforded to the user input provided by in-house counsel as opposed to outside counsel if defined to do so in the user input, or vice versa.

The natural language processor 224 is executed to derive meaning from documents submitted by users and/or administrators (e.g., discovery documents, legal opinions, memorandums, etc.) by employing known heuristics, pattern recognition, and/or meaning derivation strategies. For example, the natural language processor 224 may employ statistical inferences to define and/or modify rules by analyzing a multitude of documents. The meaning derived from documents may be used by the assessment engine 218 in determining recommendations, suggestions, probabilities, and/or estimations, as may be appreciated.

The output control 227 is executed to export decision frameworks, discussed below, as well as any information obtained, stored, and/or determined by any of the components of the computing environment 203. The export of data may be conditioned upon agreement constraints predefined by a user being satisfied, as will be discussed in greater detail below. The output control 227 may be configured to output information in any of a variety of output formats 230. As may be appreciated, output formats 230 may constantly change with the emergence of new software applications, file formats, etc. Accordingly, a modification of output formats 230 may facilitate the export of data in new formats without modification of the output control 227 or any components of the computing environment 203. The output control 227 may be further configured to encrypt and/or decrypt any data prior to the data being exported. Exported data may be used for the maintenance, examination, and enhancement of the computing environment 203.

The output control 227 is further executed to export all user input provided by one or more users as a script which may be “replayed” and/or viewed, either modified or unmodified, to further explore the relationship of the user input to the initial questions to the probability, suggestions, recommendations, etc., provided by the assessment engine 218. The output control 227 may be configured to provide decision points, the user input responsible for the selection of certain decision points, and/or the error bars on each of the thresholds on the decision points.

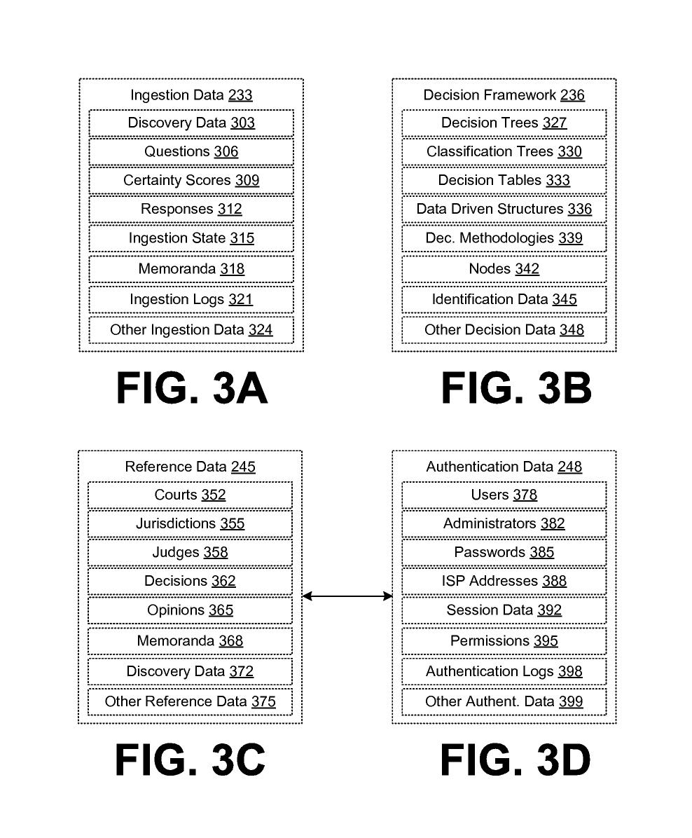

The data stored in the data store 212 includes, for example, ingestion data 233, decision frameworks 236, conditions 239, actions 242, reference data 245, authentication data 248, agreement constraints 251, training data 254, recommendations 257, statistics 260, and potentially other data. Ingestion data 233 may comprise, for example, user input provided by one or more users received the input mechanism 215 during an ingestion process. Ingestion data 233 is discussed in greater detail below with respect to FIG. 3A.

Decision frameworks 236 may comprise, for example, decision trees, classification trees, decision tables, artificial neural networks, clustering, support vector machines, and/or other decision components to determine questions to pose to a user during an ingestion process. In one embodiment, a hyperplane classifier may be employed in the classification of data by taking the dot product of parameter vector and partitioning the results based on a sign of the product. Decision frameworks 236 are discussed in greater detail below with respect to FIG. 3B.

Conditions 239 may comprise, for example, predefined conditions that may trigger an initiation of an action 242. As a non-limiting example, if a user provided thousands of discovery documents via the input mechanism 215, the assessment engine 218 may identify relevant documents (i.e., the condition) and may transmit a notification to the user identifying the relevancy of the documents (i.e., the action).

Reference data 245 may comprise, for example, discovery documents, litigation statistics, legal references (e.g., case law, scholarly articles, etc.), and/or any other information that may be used in the analysis of user input. Reference data 245 is discussed in greater detail below with respect to FIG. 3C. Authentication data 248 may comprise, for example, any information that may be used to authenticate a user and/or an administrator of the system. Authentication data 248 is discussed in greater detail below with respect to FIG. 3D. Agreement constraints 251 may comprise, for example, constraints predefined by a user of the system. For example, certain information provided by the user may be associated with certain permissions. The system may analyze the data according to those condition predefined by the user. Similarly, the system will not communicate any data with external resources 210 unless the agreement constraints 251 are met.

Training data 254 may comprise, for example, any information generated and/or used by the teaching mechanism 221 to further improve the accuracy of the system. Recommendations 257 may comprise, for example, any recommendations, probabilities, estimations, and/or suggestions that may be generated by the assessment engine 218 to be presented to the user. Similarly, the assessment engine 218 may generate and/or utilize a plurality of statistics 260, as may be appreciated. For example, the statistics 260 of a certain type of case in a particular jurisdiction before a certain judge may be used in generating a recommendation to a user.

The client 206 is representative of a plurality of client devices that may be coupled to the network 209. The client 206 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client 206 may include a display 266. The display 266 may comprise, for example, one or more devices such as liquid crystal display (LCD) displays, gas plasma-based flat panel displays, organic light emitting diode (OLED) displays, LCD projectors, or other types of display devices, etc.

The client 206 may be configured to execute various applications such as a client application 269 and/or other applications. The client application 269 may be executed in a client 206, for example, to access network content served up by the computing environment 203 and/or other servers, thereby rendering a user interface 272 on the display 266. To this end, the client application 269 may comprise, for example, a browser, a dedicated application, etc., and the user interface 272 may comprise a network page, an application screen, etc. The client 206 may be configured to execute applications beyond the client application 269 such as, for example, email applications, social networking applications, word processors, spreadsheets, and/or other applications.

External resources 210 may comprise various external computing environments configured to communicate with the computing environment 203 over network 209. For example, external resources 210 may be accessed by conducting programmatic service calls (e.g., Application Programming Interface (API) calls) in the computing environment 203. The programmatic service calls may comprise requests and/or transmissions of data. As a non-limiting example, external resources 210 may comprise world-wide databases capable of being searched programmatically and/or manually using keywords, key phrases, and/or other identifiers.

Next, a general description of the operation of the various components of the networked environment 200 is provided. To begin, it is assumed that a user seeks to participate in an ingestion process, whereby the user provides information to the input mechanism 215 about a legal case regardless of a stage of the legal case (e.g., before a complaint is filed, after a complaint is filed, after a settlement is reached, etc.). The input mechanism 215 may prompt a user with one or more questions and/or answers, thereby facilitating the receipt of an input provided by a user. For example, a user may select one or more of the answers (or provide his or her own answers) in a user interface 272 in response to the question posed. The answers provided by the user may be stored, for example, by the input mechanism 215 as ingestion data 233 in data store 212. Subsequently, the input mechanism 215 may determine one or more additional questions and/or answers to pose to the user based at least in part on the answer previously provided by the user. The input mechanism 215 may do so by employing a decision frameworks 236 comprising, for example, one or more decision algorithms and/or learning mechanisms. The previously provided user input and a state of the ingestion process may be input into the decision frameworks 236 which may then determine a subsequent action to take (e.g., posing the user with more questions, finalizing the ingestion process, providing the user with probabilities, etc.).

The assessment engine 218 may access the user input in accordance with agreement constraints 251 previously defined by a user. For example, the user input provided by a user may be subject to attorney-client confidence and a user may define that any data provided by the user input may not be communicated with any outside resources (e.g., external resources 210). Similarly, a user can define that information provided by the user is to not be considered in determination of any computations. For example, a user may desire to keep information confidential and may desire that any computations not be impacted by any information not made publicly available.

The assessment engine 218 may generate and/or determine statistics associated with the user input. In addition, recommendations 257 and/or suggestion may be generated based at least in part on the user input, the associated nodes 342 (FIG. 3B), and/or information corresponding to the associated nodes 342 in the decision framework 236. The information corresponding to the associated nodes may comprise, for example, weights or other metrics that may be used in suggesting applicable scenarios to the user. The determined results (e.g., probabilities, suggestion, recommendations, expense estimations, statistics, and/or other information) may be encoded by the assessment engine 218 and/or other component in a user interface 272 for display in a client 206. Alternatively, the determined results may be exported by the output control 227 in one or more output formats 230. The determined results may then my transmitted via e-mail, SMS, and/or other communication medium, if warranted.

Referring next to FIGS. 3A-D, shown are example embodiments of data residing in the data store 212 that may be used in automating legal assessments. As may be appreciated, ingestion data 233 may relate to data to be presented to a user during an ingestion process whereby a user is presented with one or more questions or statements prompting the user to provide information about a particular legal scenario. Accordingly, ingestion data 233 may comprise, for example, discovery data 303 relating to data that may be subject to discovery; questions 306 to be presented to a user during the ingestion process; certainty scores 309 provided by a user in response to a question or statement; responses 312 provided by a user in response to a question or statement; ingestion states 315, memoranda 318, ingestion logs 321 comprising data associated with the use of the ingestion process by a user, and/or other ingestion data 324.

With respect to FIG. 3B, data provided by a user (e.g., in response to a question and/or statement presented to the user) may be compared to one or more decision frameworks 236 that may beneficial in generating probabilities, recommendations, and/or statistics relating to the case described by the user. For example, an input provided by a user may be compared to nodes 342 residing in one or more decision trees 327, classification trees 330, decision tables 333, data driven structures 336, and/or any combination thereof. For example, Quinlan's ID3 may be employed with the recognition that simplicity causalities may be encountered which were not anticipated. In cases where an answer to a question is not a simple “yes” or “no,” a receiver operating curve (ROC) or other parametric function may be employed. Similarly, other decision methodologies 339 may be employed. Decision frameworks 236 may further comprise identification data 345 that may be used in identifying nodes 342 in the decision frameworks 236 that are relevant to input provided by a user. As may be appreciated, decision frameworks 236 may comprise other decision data 348. Nodes 342 in the decision frameworks 236 may be modified, added, removed, resequenced, or otherwise changed as the system is presented with or gather additional data.

With respect to FIG. 3C, reference data 245 may be used by the assessment engine 218 and/or the teaching mechanism 221 in determining courses of action based on references provided to the system. For example, the assessment engine 218 may be configured to identify contexts of documents, detect patterns and/or inconsistencies, and/or cognitive bias of the user by employing known methods. Thus, reference data 245 may comprise, for example, courts 352, jurisdictions 355, judges 358, decisions 362, opinions 365 or other legal documents, memoranda 368, discovery data 372, and/or any other reference data 375.

With respect to FIG. 3D, authentication data 248 may be used in authenticating users and/or administrators in accessing particular components of the system. Thus, authentication data 248 may comprise, for example, data associated with one or more users 378, administrators 382, passwords 385, Internet Service Provider (ISP) addresses 388, session data 392, permissions 395, authentication logs 398, and/or other authentication data 399.

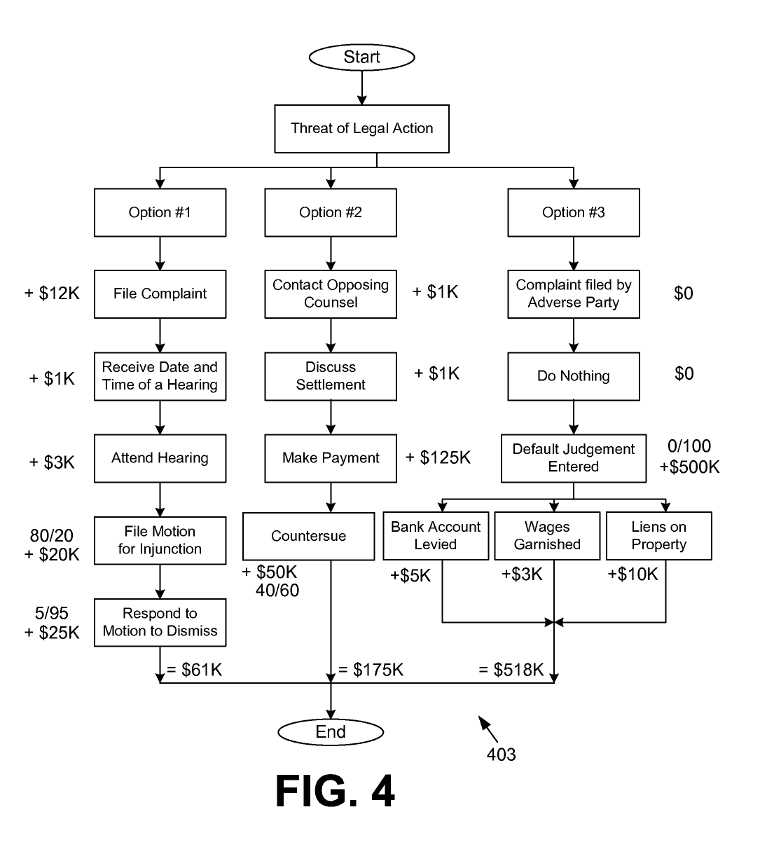

Turning now to FIG. 4, shown is non-limiting example of a legal flowchart 403 displaying example courses of actions that may be pursued in anticipation of litigation and/or after a legal complaint is filed. In the non-limiting example of FIG. 4, probabilities and/or estimated expenditures for each stage in the litigation may be determined and/or shown to the user. The analysis of each stage of the legal process may go beyond settlement and/or a verdict. For example, analysis may continue on potential post-settlement and/or post-verdict expenses. As may be appreciated, a flowchart unique to input provided by a user, based on data collected by the input mechanism 215, may be generated by the assessment engine 218 and exported via output control 227.

Although the legal flowchart 403 of FIG. 4 comprises a graphical representation, it is understood that the legal flowchart 403 may comprise, for example, data residing in a data store 212 (FIG. 2). Accordingly, each step of FIG. 4 may comprise a node of a decision framework. Although the legal flowchart 403 of FIG. 4 depicts three options, it is understood that applicable scenarios in a legal case may be substantially more complex. Moreover, it is understood that as use input associated with the one or more nodes in the decision frameworks 236 is received from a user, the probabilities and/or estimated expenditures for each node may change and/or be updated accordingly. For example, as a user provides user input and as a legal action unfolds, the applicable scenarios (represented as nodes in the flowchart) may change and/or be updated accordingly. Similarly, any determinations in associated with the node may be changed and/or updated accordingly.

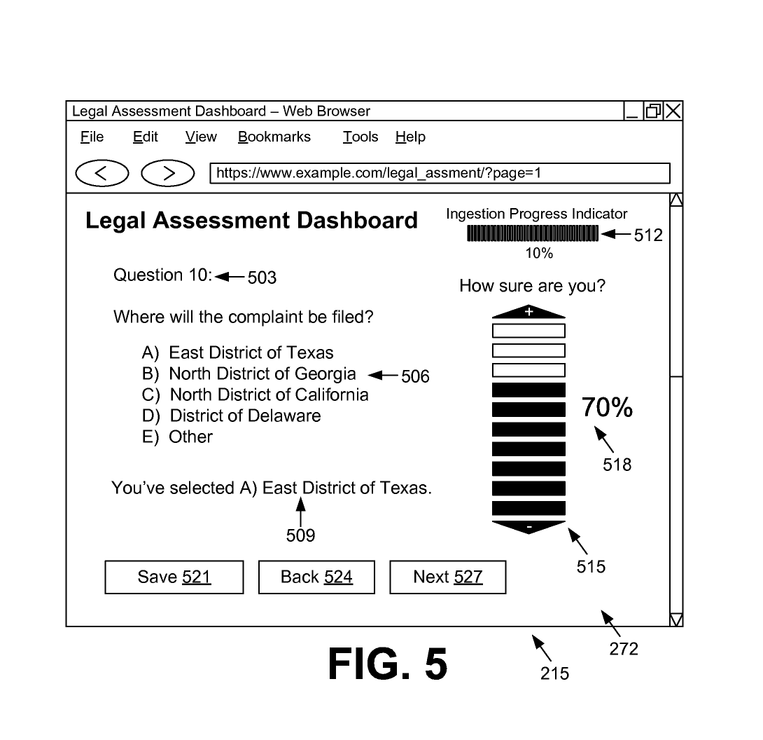

Moving on to FIG. 5, shown is an example user interface 272 that may be encoded by the input mechanism 215 and rendered in a client application 269 (FIG. 2) on a client 206 (FIG. 2). As discussed above with respect to FIG. 2, the input mechanism 215 may obtain user input from a user by posing a question 503 to the user. One or more answers 506 may be posed to the user facilitating the selection of the one or more answers 506. Assuming the one or more answers 506 posed to the user are incomplete or inadequate, the user may be provided with a series of additional user interfaces 272 (not shown) to obtain a full and complete answer to the question posed.

In response to the user selecting a respective one of the one or more answers 506, the selected answer 509 may be shown to ensure a proper response. An ingestion process indicator 512 may be used to provide the user with a state of the ingestion process. In the non-limiting example of FIG. 5, a user on question 10 may be 10% complete in the ingestion process. As may be appreciated, unique user input may generate a unique length of an ingestion process.

A confidence component 515 may facilitate the input of a confidence the user feels towards the selected answer 509. For example, a user may not feel that the answer provided by the user is correct, but may feel it is the best answer to provide at a given time. Accordingly, the user may define a confidence metric using the confidence component 515 and/or any other like component. A confidence metric 518, generated based on an engagement with the confidence component 515, may illustrate the confidence via a percentile, a metric, an icon, and/or any other like component.

As may be appreciated, a user may not be able to complete a full ingestion process in one sitting. Accordingly, the user may manually save a stage of the ingestion process, as well as any user input provided, by engaging save button 521. In an alternative embodiment, a state of the ingestion process may be saved automatically at a predefined time interval and/or responsive to the user providing an amount of user input meeting and/or exceeding a threshold. The user may navigate between questions posed to the user by engaging back button 524 and/or next button 527.

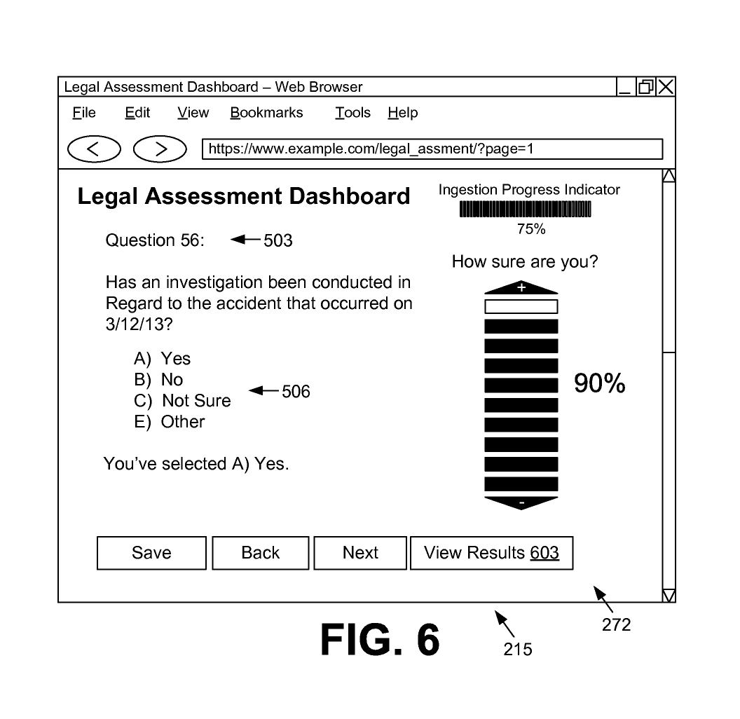

Referring next to FIG. 6, shown is an example user interface 272 that may be encoded by the input mechanism 215 and rendered in a client application 269 (FIG. 2) on a client 206 (FIG. 2). As discussed above with respect to FIG. 5, the input mechanism 215 may obtain user input from a user by posing a question 503 to the user. One or more answers 506 may be posed to the user facilitating the selection of the one or more answers 506.

As may be appreciated, a user may not have to fully complete the ingestion process for results to be generated by an assessment engine 218. Accordingly, when the assessment engine 218 has gathered enough information to generate preliminary recommendations, probabilities, estimated expenditures, etc., a view results button 603 may become available, thereby permitting a user to view generated results based on the information already provided. Although these preliminary results may be provided, the input mechanism 215 may give one or more notifications encouraging a user to fully complete the ingestion process in order to generate the best results.

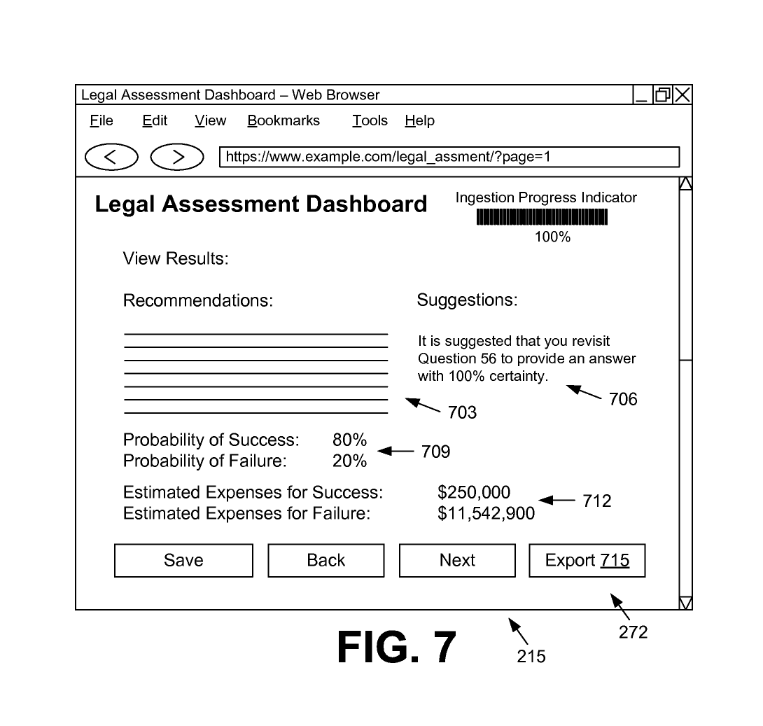

Turning now to FIG. 7, shown is an example user interface 272 that may be encoded by the input mechanism 215 and rendered in a client application 269 (FIG. 2) on a client 206 (FIG. 2). As discussed above with respect to FIG. 2, results may be generated by the assessment engine 218 based at least in part on input provided by a user over the course of an ingestion process. Results may comprise, for example, recommendations 706, suggestions 706, probabilities of success 709, estimated expenditures 712, and/or various other information generated by the assessment engine 218 by employing one or more decision frameworks 236 (FIG. 2). Recommendations 703 may comprise, for example, recommendations on whether to settle, proceed, and/or litigate, at various stages of the litigation.

Moreover, recommendations 703 may comprise advisements to conduct a certain action with respect to a case (e.g., file a motion to dismiss, hire an investigator, hire an expert witness, etc.). Suggestions 706 may comprise, for example, advising a user to return to a previous question in order to provide a complete answer with 100% certainty. Probabilities 709 may comprise, for example, probabilities of success and/or failure at certain stages of the litigation (e.g., probabilities of winning a motion to dismiss, probabilities of winning a jury trial, probabilities of winning a bench trial, etc.). Estimated expenditures 712 may comprise, for example, estimations and/or valuations of all costs (e.g., legal costs, expert witness fees, filing fees, incidental fees, etc.) of pursuing various courses of action in the litigation (e.g., probabilities of winning a motion to dismiss, probabilities of winning a jury trial, probabilities of winning a bench trial, etc.). As may be appreciated, the results generated by the assessment engine 218 may assist a user in determining the best action to pursue given the information provided to the input mechanism 215. A user may engage export of the results generated by the assessment engine 218 by engaging export button 715. Export of data is discussed in greater detail above with respect to FIG. 2.

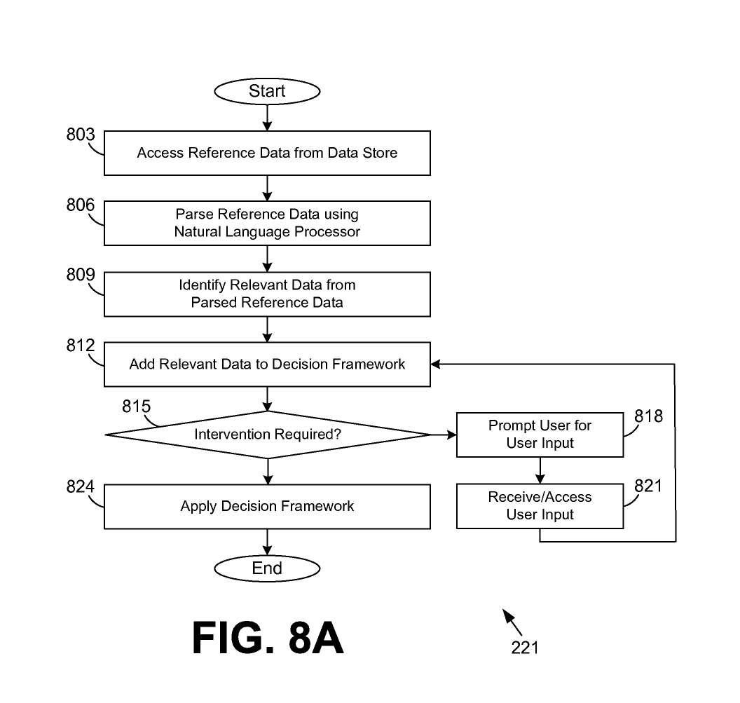

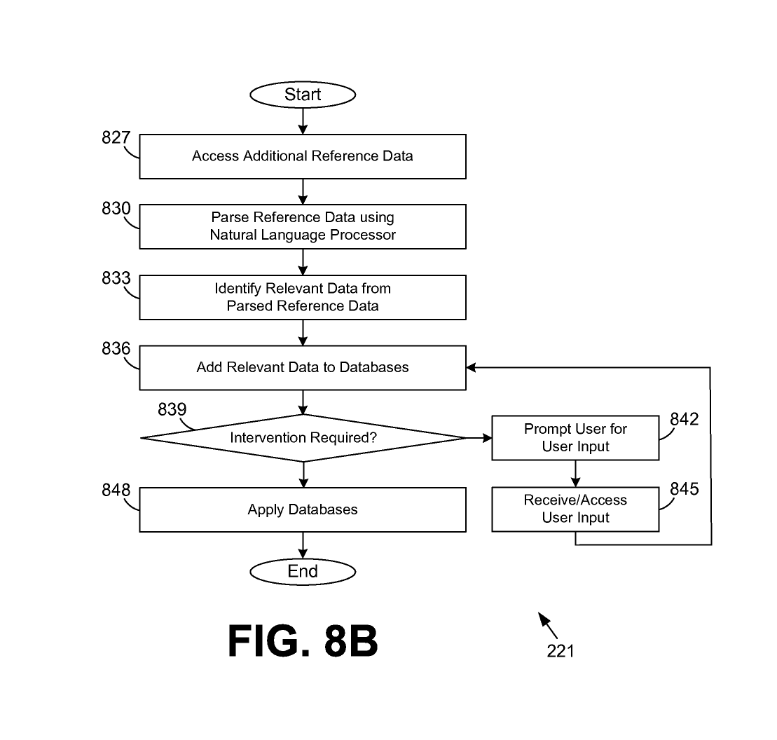

Referring next to FIG. 8A, shown is a flowchart that provides one example of the operation of a portion of the teaching mechanism 221 according to various embodiments. It is understood that the flowchart of FIG. 8A provides merely an example of the many different types of functional arrangements that may be employed to implement the operation of the portion of the teaching mechanism 221 as described herein. As an alternative, the flowchart of FIG. 8A may be viewed as depicting an example of steps of a method implemented in the computing environment 203 (FIG. 2) according to one or more embodiments.

Beginning with box 803, reference data 245 may be accessed by the teaching mechanism 221. The reference data 245 may be accessed upon a request, where the request comprises the reference data 245. Alternatively, the reference data 245 may be accessed from a data store 212 (FIG. 2), if previously stored.

In box 806, the reference data 245 may be parsed via the natural language processor 224 (FIG. 2), or other similar component. Parsing of the reference data 245 may comprise, for example, identifying predefined keywords or phrases embedded within the reference data 245, either in a document and/or in the source code of a document. Parsing of the reference data 245 may further comprise, for example, deriving meaning from words, word clusters, phrases, sentences, paragraphs, and/or other sections of content.

In box 809, relevant data may be identified by the teaching mechanism 221 from the parsed reference data 245. In box 812, the identified relevant data may be added to the decision framework 236.

In box 815, it is determined whether an intervention is required (or warranted). An intervention may comprise requesting a user and/or an administrator for additional information associated with the reference data 245. Assuming that an intervention is required (or warranted), a user and/or administrator may be prompted to provide user input that may be associated with the reference data 245, in box 818. In box 821, the user input may be received by the teaching mechanism 221, or other component of the computing environment 203, and stored in associated with the reference data 245. In box 824, the decision framework 236 may be applied. Application of the decision framework 236 comprises, for example, utilizing the decision framework 236 during ingestion of user input. Moreover, the decision framework 236 may be used in determination of recommendations 257, probabilities, calculations, etc.

Referring next to FIG. 8B, shown is a flowchart that provides one example of the operation of a portion of the teaching mechanism 221 according to various embodiments. It is understood that the flowchart of FIG. 8B provides merely an example of the many different types of functional arrangements that may be employed to implement the operation of the portion of the teaching mechanism 221 as described herein. As an alternative, the flowchart of FIG. 8B may be viewed as depicting an example of steps of a method implemented in the computing environment 203 (FIG. 2) according to one or more embodiments.

Beginning with box 827, reference data 245 may be accessed by the teaching mechanism 221. The reference data 245 may be accessed upon a request, where the request comprises the reference data 245. Alternatively, the reference data 245 may be accessed from a data store 212 (FIG. 2), if previously stored.

In box 830, the reference data 245 may be parsed via the natural language processor 224 (FIG. 2), or other similar component. Parsing of the reference data 245 may comprise, for example, identifying predefined keywords or phrases embedded within the reference data 245, either in a document and/or in the source code of a document. Parsing of the reference data 245 may further comprise, for example, deriving meaning from words, word clusters, phrases, sentences, paragraphs, and/or other sections of content.

In box 833, relevant data may be identified by the teaching mechanism 221 from the parsed reference data 245. In box 836, the identified relevant data may be added to the data store 212. Similarly, the identified relevant data may be used to modify existing data in the data store 212. Accordingly, an up-to-date database may automatically be provided by the teaching mechanism 221.

Similar to FIG. 8A, in box 839, it is determined whether an intervention is required (or warranted). An intervention may comprise requesting a user and/or an administrator for additional information associated with the reference data 245. The additional information may be provided, for example, via a “wizard” and/or similar process (e.g., providing a series of user interfaces to the user requesting additional information and/or corrective information). Assuming that an intervention is required (or warranted), a user and/or administrator may be prompted to provide user input that may be associated with the reference data 245, in box 842. In box 845, the user input may be received by the teaching mechanism 221, or other component of the computing environment 203, and stored in associated with the reference data 245. In box 848, the data store 212 may be applied to determination of estimated expenditures, probabilities, recommendations, suggestions, etc.

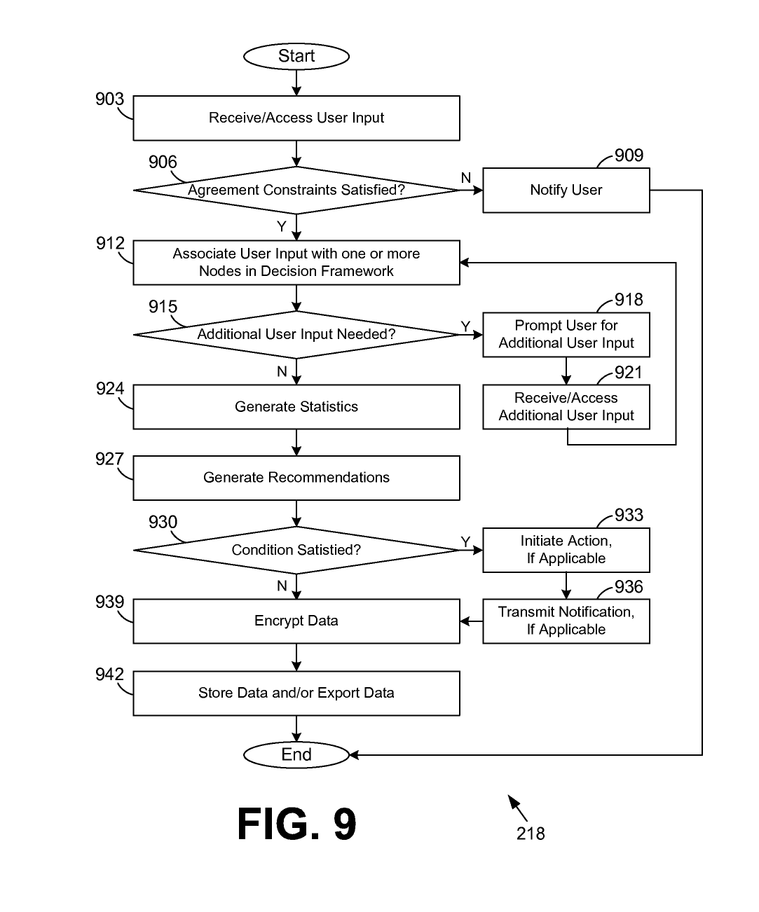

Turning now to FIG. 9, shown is a flowchart that provides one example of the operation of a portion of the assessment engine 218 according to various embodiments. It is understood that the flowchart of FIG. 9 provides merely an example of the many different types of functional arrangements that may be employed to implement the operation of the portion of the assessment engine 218 as described herein. As an alternative, the flowchart of FIG. 9 may be viewed as depicting an example of steps of a method implemented in the computing environment 203 (FIG. 9) according to one or more embodiments.

Beginning with box 903, user input may be received and/or accessed by the assessment engine 218. For example, the user input may be received in a request. Alternatively, the user input may be accessed from a data store 212 (FIG. 2), if previously stored.

In box 906, it is determined whether predefined agreement constraints 251 are satisfied. Agreement constraints 251 may comprise, for example, constraints predefined by a user regarding the use of data provided by the user. For instance, a user may have previously defined agreement constraints 251 to state that the data provided by the user may be used exclusively by the assessment engine 218, but may not be used by external resources 208 (e.g., off-server resources). Accordingly, the agreement constraints 251 predefined by a user may act as permissions defining which components may use which user data.

If the agreement constraints 251 may not be satisfied, the user may be notified, as shown in box 909. No further analysis of the user input may be warranted, thus complying with the agreement constraints 251 predefined by the user. Alternatively, if the agreement constraints 251 may be satisfied during analysis of the user input, in box 912, the user input may be associated with one or more nodes 342 in a decision framework 236. As may be appreciated, the nodes 342 may relate to applicable scenarios in the decision framework. The user input may be associated with these nodes (e.g., applicable scenarios), and a recommendation may be determined based at least in part on successive nodes in the decision framework. The recommendation may be based at least in part on a probability of success for the node and/or successive nodes and/or an estimated expenditure for the node and/or successive nodes.

In box 915, it is determined whether additional user input is needed. If so, in box 918, the user may be prompted for the additional user input. In box 921, the additional user input may be received by the input mechanism 215, the assessment engine 218, and/or other component of the computing environment 203. In box 924, statistics 260 associated with the user input may be generated and/or stored in, for example, the data store 212. In box 927, recommendations 257 may be generated based at least in part on the user input and/or the associated nodes 342 in the decision framework 236. In box 930, it may be determined whether any conditions are satisfied that may warrant an automatic initiation of an event. If so, in box 933, the action may be initiated and, in box 936, any notifications may be transmitted (e.g., to the users or to the administrators). In box 939, any data may be encrypted if warranted to do so. In box 942, the data may be stored and/or exported via output control 227 or like component.

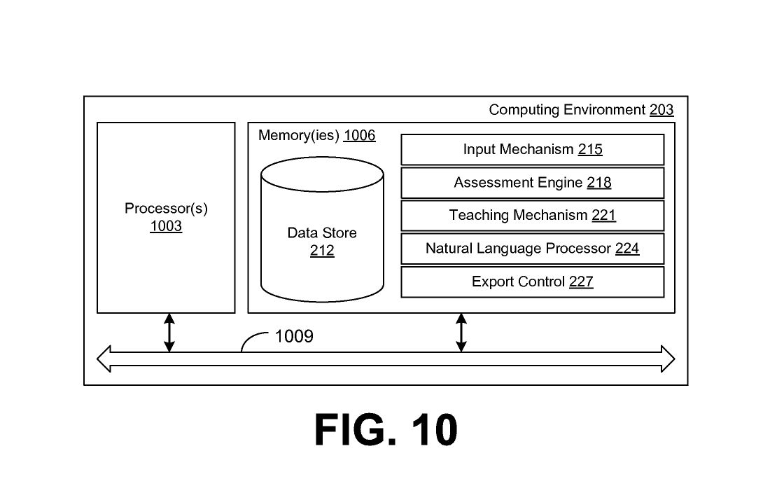

With reference to FIG. 10, shown is a schematic block diagram of the computing environment 203 according to an embodiment of the present disclosure. The computing environment 203 includes one or more computing devices and/or computing environments 203. Each computing environment 203 includes at least one processor circuit, for example, having a processor 1003 and a memory 1006, both of which are coupled to a local interface 1009. To this end, each computing environment 203 may comprise, for example, at least one server computer or like device. The local interface 1009 may comprise, for example, a data bus with an accompanying address/control bus or other bus structure as can be appreciated.

Stored in the memory 1006 are both data and several components that are executable by the processor 1003. In particular, stored in the memory 1006 and executable by the processor 1003 are the input mechanism 215, the assessment engine 218, the teaching mechanism 221, the natural language processor 224, the output control 227, and potentially other applications. Also stored in the memory 1006 may be a data store 212 and other data. In addition, an operating system may be stored in the memory 1006 and executable by the processor 1003.

It is understood that there may be other applications that are stored in the memory 1006 and are executable by the processor 1003 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 1006 and are executable by the processor 1003. In this respect, the term “executable” means a program file that is in a form that can ultimately be run by the processor 1003. Examples of executable programs may be, for example, a compiled program that can be translated into machine code in a format that can be loaded into a random access portion of the memory 1006 and run by the processor 1003, source code that may be expressed in proper format such as object code that is capable of being loaded into a random access portion of the memory 1006 and executed by the processor 1003, or source code that may be interpreted by another executable program to generate instructions in a random access portion of the memory 1006 to be executed by the processor 1003, etc. An executable program may be stored in any portion or component of the memory 1006 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1006 is defined herein as including both volatile and nonvolatile memory and data storage components. Volatile components are those that do not retain data values upon loss of power. Nonvolatile components are those that retain data upon a loss of power. Thus, the memory 1006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1003 may represent multiple processors 1003 and/or multiple processor cores and the memory 1006 may represent multiple memories 1006 that operate in parallel processing circuits, respectively. In such a case, the local interface 1009 may be an appropriate network that facilitates communication between any two of the multiple processors 1003, between any processor 1003 and any of the memories 1006, or between any two of the memories 1006, etc. The local interface 1009 may comprise additional systems designed to coordinate this communication, including, for example, performing load balancing. The processor 1003 may be of electrical or of some other available construction.

Although the input mechanism 215, the assessment engine 218, the teaching mechanism 221, the natural language processor 224, the output control 227, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 8 and 9 show the functionality and operation of an implementation of portions of a system for automating legal assessments. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 1003 in a computer system or other system. The machine code may be converted from the source code, etc. If embodied in hardware, each block may represent a circuit or a number of interconnected circuits to implement the specified logical function(s).

Although the flowcharts of FIGS. 8 and 9 show a specific order of execution, it is understood that the order of execution may differ from that which is depicted. For example, the order of execution of two or more blocks may be scrambled relative to the order shown. Also, two or more blocks shown in succession in FIGS. 8 and 9 may be executed concurrently or with partial concurrence. Further, in some embodiments, one or more of the blocks shown in FIGS. 8 and 9 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the input mechanism 215, the assessment engine 218, the teaching mechanism 221, the natural language processor 224, the output control 227, that comprises software or code can be embodied in any non-transitory computer-readable medium for use by or in connection with an instruction execution system such as, for example, a processor 1003 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A method of determining a course of action in association with a legal case comprising:
receiving user input from an authenticated user via an input mechanism, the user input associated with the legal case;
associating the user input with at least one decision framework; and
generating a recommendation to be presented to the user, the recommendation based on the at least one decision framework.

2. The method of claim 1, wherein associating the user input with at least one decision framework further comprises:
determining an applicable scenario based on a node residing in the decision framework;
associating the user input with the node in the decision framework; and
determining the recommendation based in part on successive nodes in the decision framework.

3. The method of claim 1, wherein the user input used in associating the user input with the at least one decision framework satisfies at least one agreement constraint, wherein the agreement constraint comprises criteria predefined by a user in association with a use of the user input.

4. The method of claim 1, further comprising generating a probability of success for at least one step of the legal case.

5. The method of claim 1, further comprising generating an estimated expenditure for at least one step of the legal case.

6. The method of claim 1, further comprising exporting the recommendation responsive to a predefined constraint permitting an export of the recommendation.

7. The method of claim 1, wherein the recommendation is to settle the legal case or to litigate the legal case.

8. The method of claim 1, wherein at least a portion of the recommendation is determined by a computing device.

9. A system, comprising:
at least one computing device comprising an application executable on the at least one computing device, the application comprising:
logic that receives user input from a user via an input mechanism, the user input associated with a legal case;
logic that associates the user input with a node in a decision framework; and
logic that generates a recommendation to be presented to the user, the recommendation based at least in part on the node in the decision framework.

10. The method of claim 1, wherein associating the user input with at least one decision framework further comprises:
determining an applicable scenario based on a node residing in the decision framework;
associating the user input with the node in the decision framework; and
determining the recommendation based in part on successive nodes in the decision framework.

11. The system of claim 9, wherein the user input used in the association with the at least one decision framework satisfies at least one agreement constraint, wherein the agreement constraint comprises criteria predefined by a user in association with a use of the user input.

12. The system of claim 9, further comprising the step of generating a probability of success for at least one step in a legal process.

13. The system of claim 9, further comprising the step of generating an estimated expenditure for at least one step in a legal process.

14. The system of claim 9, further comprising the step of exporting the recommendation responsive to a predefined constraint permitting an export of the recommendation.

15. The system of claim 9, wherein the recommendation is to settle the legal case or to litigate the legal case.

16. The system of claim 9, further comprising the step of exporting the recommendation responsive to a predefined constraint permitting an export of the recommendation.

17. A non-transitory computer-readable medium embodying a program executable in at least one computing device, comprising:
code that receives user input from a user via an input mechanism, the user input associated with a legal case;
code that associates the user input with a node in a decision framework; and
code that generates a recommendation to be presented to the user, the recommendation based at least in part on the node in the decision framework.

18. The non-transitory computer-readable medium of claim 17, wherein the user input used in the code that associates the at least one decision framework satisfies at least one agreement constraint, wherein the agreement constraint comprises criteria predefined by a user in association with a use of the user input.

19. The non-transitory computer-readable medium of claim 17, further comprises code that generates a probability of success for at least one step in a legal process.

20. The non-transitory computer-readable medium of claim 17, further comprising code that generates an estimated expenditure for at least one step in a legal process.
